(19) United States
(12) Patent Application Publication
(10) Pub. No.: US 2015/0036721 A1
(43) Pub. Date: Feb. 5, 2015

(54) TEMPERATURE MEASURING MODULE HAVING POSITION COMPENSATION

(71) Applicant: Phoenix Contact GmbH & Co. KG, Blomberg (DE)

(72) Inventors: Hubertus Lohre, Steinheim (DE); Norbert Joestingmeier, Lemgo (DE)

(21) Appl. No.: 14/378,330

(22) PCT Filed: Feb. 21, 2013
(86) PCT No.: PCT/EP2013/000501

§ 371 Date: Aug. 13, 2014

(30) Foreign Application Priority Data
Feb. 23, 2012 (DE) 10 2012 003 407.5

(51) Int. Cl. G01K 7/10; G01K 7/16; G01K 7/02

(52) U.S. Cl. CPC G01K 7/10; G01K 7/021; G01K 7/023; G01K 7/16
USPC 374/179

(57) ABSTRACT

A temperature measurement module having position compensation provided for connection to at least one thermocouple includes a temperature-dependent resistor, via which a first temperature of a reference point of the thermocouple can be detected as a resistance voltage. The temperature measurement module includes an evaluation circuit which allows a first temperature value of a measurement point to be determined via the resistance voltage and a thermoelectric voltage of the thermocouple. The temperature measurement module includes a compensation mechanism which modifies the first temperature value depending on the installation position of the temperature measurement module so that thermal influences of the evaluation circuit, which have a thermal effect on at least one of the reference point or the measurement point depending on position, are compensated at least in part.

### CROSS-REFERENCE TO RELATED APPLICATIONS

This application is a U.S. National Phase application under 35 U.S.C. §371 of International Application No. PCT/EP2013/000501, filed on Feb. 21, 2013, and claims benefit to German Patent Application No. DE 10 2012 003 407.5, filed on Feb. 23, 2012. The International Application was published in German on Aug. 29, 2013, as WO 2013/124062 A2 under PCT Article 21 (2).

### FIELD

The invention relates to a temperature measurement module.

### BACKGROUND

Thermocouples are known from the prior art which are used for measuring high temperatures. As a rule, said thermocouples consist of two metallic conductors which are connected in an electrically conductive and punctiform manner to a point. In this case, the two metallic conductors have a different chemical composition.

Conventionally, the punctiform connecting point, which is also referred to as a hot junction, is attached to the point to be measured, while the two other ends of the metallic conductors, which are also referred to as cold junctions, are guided to a reference point.

If the measurement point and the reference point have a different temperature, a voltage is formed between the unconnected conductor ends which is also referred to as a thermoelectric voltage or thermal electromotive force. This property is also known as the Seebeck effect. The following relationship applies to the thermoelectric voltage:

$${\int }_{{r}_{1}}^{{r}_{2}} ( {S}_{2} ( T ) - {S}_{1} ( T ) ) d T .$$

In this case, T2 is the temperature of the measurement point and T1 is the temperature of the reference point. The Seebeck coefficient S1 is a matter constant of the first conductor and the Seebeck coefficient S2 is a matter constant of the second conductor. It should be noted that the Seebeck coefficient may also be dependent on the temperature.

The Seebeck coefficient has the dimension of a voltage per temperature difference (volt/Kelvin). The typical magnitude is 10 μV/K for metals at room temperature.

For small temperature differences and constant values for the Seebeck coefficients, the formula is simplified to U=(S2−S1)·(T2−T1).

Since the thermoelectric voltage only indicates a temperature difference, the temperature of the reference point still has to be determined for an absolute temperature measurement value. This is carried out by another temperature sensor, for example a temperature-dependent resistor.

In industry, measurement systems of this type are installed in switch cabinets in a modular manner. In this case, the evaluation circuit and the reference point are positioned close to each other, while the measurement point can be further away. Typically, the evaluation circuit is positioned in a temperature measurement module which is connected to a thermocouple or a plurality of thermocouples.

It has however been shown that the temperature measurement values of the reference point are distorted depending on the installation position of the temperature measurement module.

Although, as a rule, there is the possibility of determining and setting compensation locally by means of a comparative measurement, this approach is time-consuming and prone to errors.

### SUMMARY

In an embodiment, the present invention provides a temperature measurement module having position compensation provided for connection to at least one thermocouple. The at least one thermocouple includes at least two metallic conductors which have a first temperature at a reference point and a second temperature at a measurement point. The at least two metallic conductors having a different chemical composition at least in part. The at least two metallic conductors are connected in an electrically conductive and punctiform manner to a measurement point. A thermoelectric voltage is formed at the reference point between the at least two metallic conductors depending on the temperature difference between the first temperature and the second temperature. The temperature measurement module includes a temperature-dependent resistor, via which a first temperature of a reference point of the thermocouple can be detected as a resistance voltage. The temperature measurement module includes an evaluation circuit which allows a first temperature value of a measurement point to be determined via the resistance voltage and a thermoelectric voltage of the thermocouple. The temperature measurement module includes a compensation device which modifies the first temperature value depending on the installation position of the temperature measurement module so that thermal influences of the evaluation circuit, which have a thermal effect on at least one of the reference point or the measurement point depending on position, are compensated at least in part

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows an embodiment of a temperature measurement module according to the invention, and

FIG. 2 shows details according to various embodiments of a temperature measurement module according to the invention.

### DETAILED DESCRIPTION

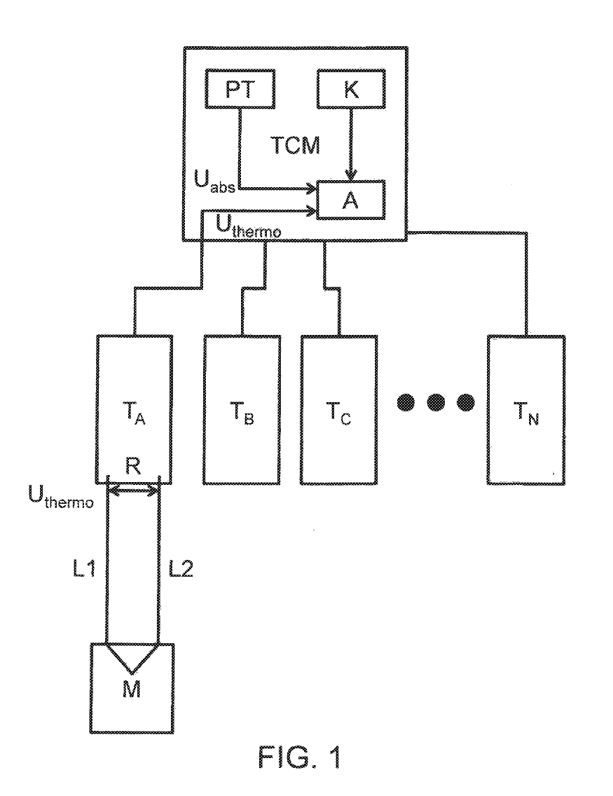

The invention in an embodiment provides a temperature measurement module TCM which is shown by way of example in FIG. 1. The temperature measurement module TCM is provided for connection to a thermocouple TA or a plurality of thermocouples TA, TB, TC, . . . TN.

A thermocouple comprises two metallic conductors L1, L2 which by way of example are shown only on one thermocouple TA. The metallic conductors L1, L2 have a first temperature T1 at a reference point R and a further temperature T2 at a measurement point M, for example at the object to be measured. The two metallic conductors L1, L2 have a different chemical composition at least in part. The two metallic conductors L1, L2 are connected in an electrically conductive and punctiform manner to the measurement point M. A thermoelectric voltage Uthermo is formed at the reference point R between the two conductors L1 and L2 depending on the temperature difference ΔT=T2−T1 between the first temperature T1 and the second temperature T2.

The temperature measurement module TCM also comprises a temperature-dependent resistor PT. Via the temperature-dependent resistor PT given by way of example, the temperature T1 of the reference point R can be detected, for example as a resistance voltage Uabs. In this case, it is only important that a measured variable is detected from which an absolute temperature can be derived.

The temperature measurement module TCM also comprises an evaluation circuit A which allows a first temperature value Tmess1 of the measurement point M to be determined by means of the resistance voltage Uabs or of a comparable signal which reflects the absolute temperature T1 of the reference point R and by means of the thermoelectric voltage Uthermo or of a comparable signal which reflects the temperature difference ΔT.

In order for it to be possible for thermal influences of the evaluation circuit A which have a thermal effect on the reference point R and/or on the measurement point M depending on position to be compensated at least in part, the temperature measurement module TCM also comprises a compensation means K which modifies the first temperature value Tmess1 depending on the installation position of the temperature measurement module TCM so that thermal influences of the evaluation circuit A are compensated.

The modifications to be made may for example be determined for a product line and may be predetermined, or, however, in order for it to be possible to compensate tolerances, each individual temperature measurement module TCM may be individually programmed for individual positions. This means that the compensation is already predetermined for individual installation positions.

Depending on the possibilities available, the compensation means K can provide a digital compensation or an analogue compensation, for example in the form of a resistor network or the like.

In addition, it may be provided that the compensation means K can compensate a horizontal installation, a vertical installation or a flat installation, or even various combinations thereof.

It may for example thus be provided that for each of these installation positions, a switch position is provided on a common setting, or, however, a separate setting may be provided for each of these positions.

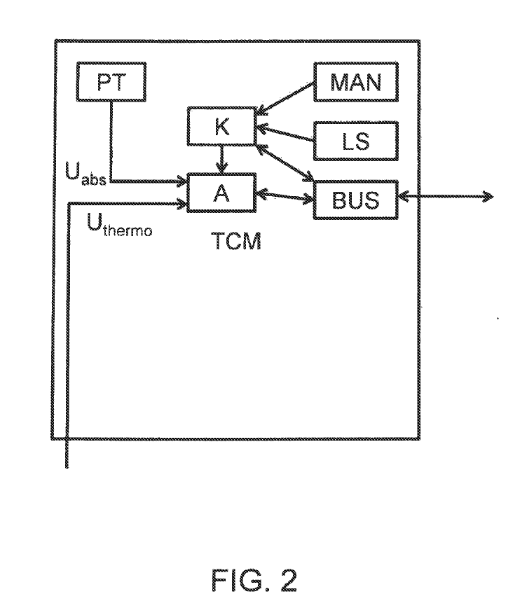

For example, as shown in FIG. 2, the type of compensation K can be carried out on the device by a selection MAN. This may for example be carried out via a coding switch which acts on an analogue switch or a digital switch.

Furthermore, the type of compensation K can be carried out via a bus system BUS by a selection and can also be queried by said system according to the circumstances.

Furthermore, it may also be provided that the type of compensation K is identified and selected by a position sensor LS in the temperature measurement module TCM. Suitable position sensors may for example be produced on the basis of simple inclination sensors, liquid switches or the like.

Furthermore, it may also be provided that the identified position and/or set position can be queried via a bus system.

Of course, these setting variants may also be provided in many different combinations, it then also being possible to provide that a setting variant excludes another setting variant. For example, it may be provided that a local manual setting MAN takes precedence over all other setting variants.

If a temperature measurement module TCM according to the invention is installed, then during installation the position can be set locally, or identified and set, via one of the various configuration methods.

The temperature measurement value modified by the compensation means K can then be made available via the bus system BUS and/or via a display provided on the temperature measurement module TCM.

By means of the above-described invention, it is thus possible, in a simple manner, to remedy errors which previously arose owing to different installation positions, and to thus provide a simple and safe solution.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Evaluation circuit A
Compensation means K
Metallic conductors L1, L2
Position sensor LS
Measurement point M
Temperature-dependent resistor PT
Reference point R
Thermocouple TA, TB, TC, . . . TN
Temperature measurement module TCM
First temperature T1
Second temperature T2
Temperature difference ΔT
Thermoelectric voltage Uthermo
Resistance voltage Uabs

1. A temperature measurement module having position compensation, the temperature measurement module being provided for connection to at least one thermocouple comprising at least two metallic conductors which have a first temperature at a reference point and a second temperature at a measurement point, the at least two metallic conductors having a different chemical composition at least in part, the at least two metallic conductors being connected in an electrically conductive and punctiform manner to a measurement point, a thermoelectric voltage being formed at the reference point between the at least two metallic conductors depending on the temperature difference between the first temperature and the second temperature, the temperature measurement module comprising:
a temperature-dependent resistor, via which the temperature of the reference point can be detected as a resistance voltage;
an evaluation circuit which allows a first temperature value of the measurement point to be determined via the resistance voltage and the thermoelectric voltage; and
a compensation device which modifies the first temperature value depending on the installation position of the temperature measurement module so that thermal influences of the evaluation circuit, which have a thermal effect on at least one of the reference point or the measurement point depending on position, are compensated at least in part.

2. The temperature measurement module according to claim 1, wherein the compensation device provides a digital compensation.

3. The temperature measurement module according to claim 1, wherein the compensation device compensates a horizontal installation, a vertical installation or a flat installation.

4. The temperature measurement module according to claim 1, wherein a type of the compensation can be carried out by a selection.

5. The temperature measurement module according to wherein a type of the compensation can be carried out via a bus system by a selection.

6. The temperature measurement module according to claim 1, wherein a type of the compensation is selectable by a position sensor in the temperature measurement module.
